(19) United States
(12) Patent Application Publication
(10) Pub. No.: US 2009/0206985 A1
(43) Pub. Date: Aug. 20, 2009

(54) CONTROL METHOD AND SYSTEM FOR CONTROLLING ACCESS THROUGH AN AUTOMATED DOOR

(75) Inventors: Chun-Hua HSIA, Taipei County (TW); Ching-Shun WANG, Taipei County (TW); Ming-Chung WANG, Taipei County (TW)

Correspondence Address: MCNEES WALLACE & NURICK LLC, 100 PINE STREET, P.O. BOX 1166, HARRISBURG, PA, 17108-1166, US

(73) Assignee: ADVANCED CONNECTION TECHNOLOGY INC., Taipei County (TW)

(21) Appl. No.: 12/033,208

(22) Filed: Feb. 19, 2008

(51) Int. Cl. G06F 7/04

(52) U.S. Cl. 340/5.7

(57) ABSTRACT

A control method for controlling access through an automated door is performed by a control system that includes a first communications unit, a processor and a storage space. The control method includes the steps of: a) through the first communications unit, receiving a communications signal transmitted from a second communications unit that has a second identification code and that transmits the communications signal upon dialing of the first identification code, and obtaining the second identification code of the second communications unit from the communications signal; and b) through the processor, comparing the second identification code obtained in step a) with at least one authorized identification code stored in the storage space, and controlling the automated door to permit access therethrough when a match is found.

### BACKGROUND OF THE INVENTION

1. Field of the Invention

This invention relates to a control method and system for controlling access through an automated door, more particularly to a method and system permitting remote control of access through an automated door.

2. Description of the Related Art

FIG. 1 illustrates a conventional automated door control system 9, the main function of which is to restrict entry into particular areas. Essential components of the system 9 include a sensor 91, a power supply 92, a control panel 93, and an electronic lock 94. To gain access through the system 9, a user is required to present an identification card 8 with an identification code to be read by the sensor 91. Upon successful verification of the identification code by the control panel 93, the control panel 93 performs control to unlock the electronic lock 94(either by supplying electricity or cutting off the supply of electricity, depending on the type of electronic lock 94). The need for a card not only adds to the operating costs, but also inconveniences the user, since he or she may easily forget to bring the card or misplace the card.

Another conventional automated door control system employs a wireless communication device and uses International Mobile Subscriber Identity (IMSI) to confirm the user's identity. Although this system would eliminate the need for an identification card, it would still require the user to interact with the system at close range, much like the previously described conventional system.

### SUMMARY OF THE INVENTION

Therefore, the object of the present invention is to provide a control method and system for controlling access through an automated door that are capable of overcoming the aforementioned drawbacks of the prior art.

According to one aspect of the present invention, there is provided a control method for controlling access through an automated door. The control method is performed by a control system that includes a first communications unit, a processor, and a storage space. The storage space is for storing at least one authorized identification code. The first communications unit is assigned a first identification code. The control method comprises the steps of:

a) through the first communications unit, receiving a communications signal transmitted from a second communications unit that has a second identification code and that transmits the communications signal upon dialing of the first identification code, and obtaining the second identification code of the second communications unit from the communications signal; and

b) through the processor, comparing the second identification code obtained in step a) with the at least one authorized identification code stored in the storage space, and controlling the automated door to permit access therethrough when a match is found.

According to another aspect of the present invention, there is provided a control system for controlling access through an automated door. The control system comprises a first communications unit, a memory unit, and a processor.

The first communications unit is assigned with a first identification code and is operable to receive a communications signal transmitted from a second communications unit. The second communications unit has a second identification code and transmits the communications signal upon dialing of the first identification code. The first communications unit is further operable to obtain the second identification code of the second communications unit from the communications signal.

The memory unit is for storing at least one authorized identification code.

The processor is coupled to the first communications unit and the memory unit. The processor is operable to compare the second identification code obtained by the first communications unit with the at least one authorized identification code stored in the memory unit. When a match is found, the processor controls the automated door to permit access through the automated door.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional automated door control system;

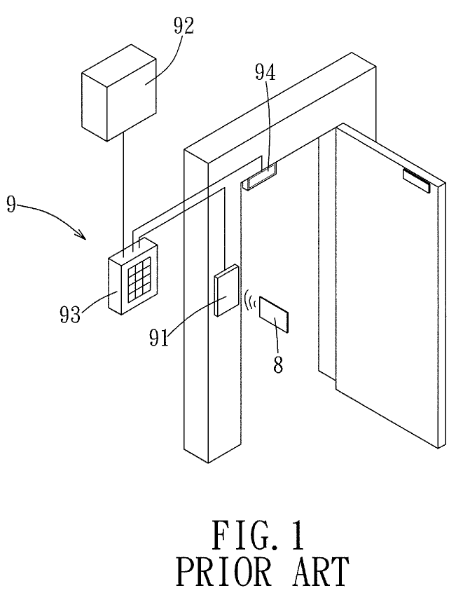

FIG. 2 is a schematic diagram of a preferred embodiment of an automated door control system according to the present invention;

FIG. 3 is a schematic circuit block diagram of the preferred embodiment of an automated door control system according to the present invention; and

FIG. 4 is a flow chart of a preferred embodiment of an automated door control method according to the present invention.

### DETAILED DESCRIPTION OF THE PREFERRED EMBODIMENT

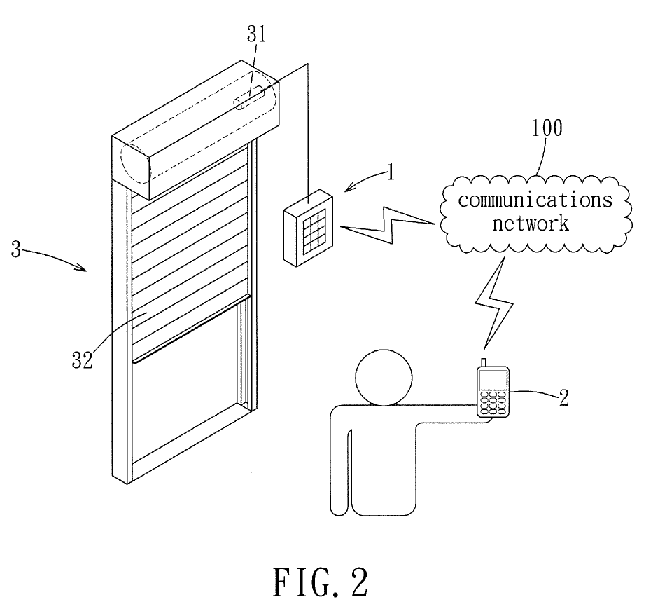

FIG. 2 illustrates a preferred embodiment of a control system for controlling access through an automated door.

In this embodiment, the automated door control system 1 has a first identification code and can receive a communications signal transmitted from a communications unit, preferably a cellular phone 2. The cellular phone 2 has a second identification code and transmits the communications signal over a wireless communications network 100 upon dialing the first identification code.

The automated door control system 1 can obtain the second identification code from the communications signal. Once the second identification code has been obtained, the door control system 1 can compare the second identification code to a list of authorized identification codes. If the second identification code is found on the list, the automated door control system 1 performs suitable control to permit access through the automated door 3.

Preferably, the automated door 3 includes a motor 31 and a metal roll up door 32 that can be driven by the motor 31 to roll up the door 32.

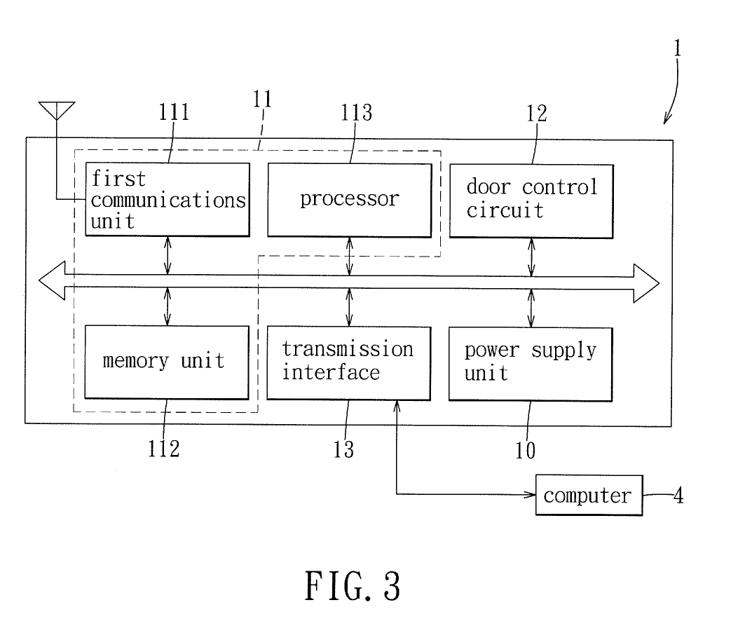

Referring to FIG. 3, the automated door control system 1 of the preferred embodiment includes a power supply unit 10 that provides power to the control system 1, a communications module 11, a door control circuit 12 and a transmission interface 13 for connecting to an external device, such as a computer.

The communications module 11 of the embodiment is provided with a SIM card, and includes a first communications unit 111, a memory unit 112, and a processor 113.

Referring to FIGS. 2 and 3, the first communications unit 111 is assigned the first identification code, i.e., a phone number assigned to the SIM card of the communications module 11. The memory unit 112 is a storage space of the SIM card and is used to store a directory of contacts. The memory unit 112 further stores at least one authorized identification code in a security list. The second communications unit, which in this embodiment is the cellular phone 2, is also provided with a SIM card, and the second identification code is a phone number assigned to the SIM card of the cellular phone 2. The first communications unit 111 is operable to receive the communications signal transmitted over the network 100 by the cellular phone 2 upon dialing of the first identification code, and is further operable to obtain the second identification code from the communications signal.

In practice, the first communications unit 111 does not pick up calls received from the cellular phone 2 so as to avoid network provider charges. Nonetheless, the first communications unit 111 is notified through the communications network 100 of the transmission of the communications signal from the cellular phone 2, and can obtain the second identification code of the cellular phone 2 through this notification.

In this embodiment, the processor 113 is coupled to the first communications unit 111 and the memory unit 112. The processor 113 is operable to compare the second identification code obtained by the first communications unit 111 with the at least one authorized identification code stored in the memory unit 112. If a match is found, the processor 113 controls the automated door 3 through the door control circuit 12 to permit access through the automated door 3.

In addition, when a match is found, the processor 113 can record the second identification code obtained by the first communications unit 111 in an entry/exit log stored in the memory unit 112.

In this embodiment, the transmission interface 13 is operably associated with the memory unit 112 to permit the uploading of data to and the downloading of data from the computer 4. In particular, when the computer 4 is connected to the control system 1, the automated door control system 1 can download an updated list of authorized identification codes from the computer 4. The entry/exit log may also be uploaded to the computer 4 for review by an administrator.

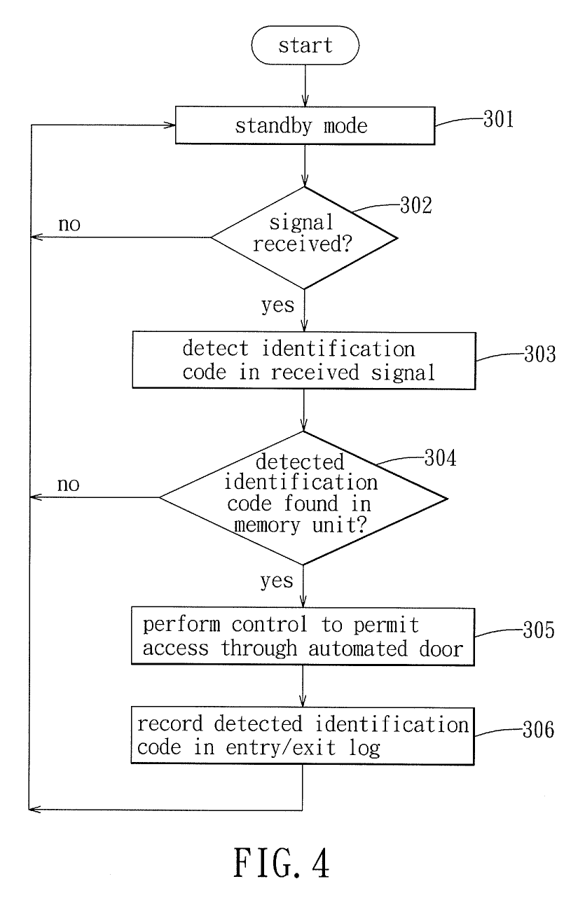

The preferred embodiment of the method for controlling the automated door 3 includes the steps shown in FIG. 4.

In step 301, the control system 1 is in a standby mode.

In step 302, the control system 1 determines, through the first communications unit 111, whether a signal transmitted from a second communications unit 2 is being received. If a signal is being received, the flow proceeds to step 303. If no signal is being received, the flow returns to step 301.

In step 303, the control system 1, through the first communications unit 111, detects the second identification code of the second communications unit 2. The flow then proceeds to step 304.

In step 304, the control system 1, through the processor 113, compares the identification code obtained in step 303 with authorized identification codes stored in the memory unit 112. If a match is found, the control system 1 performs control to permit access through the automated door 3 in step 305, and the flow proceeds to step 306. If no match is found, the flow returns to step 301.

In step 306, the control system 1 records the matching second identification code in the entry/exit log in the memory unit 112.

In the present invention, the identification code (i.e., phone number) of a common portable communications device, such as a cellular phone, is used instead of an identification card to verify the identity of a person wishing to gain access through an automated door, thereby effectively overcoming the aforementioned drawbacks associated with use of the identification card.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A control method for controlling access through an automated door, said control method being performed by a control system that includes a first communications unit, a processor, and a storage space for storing at least one authorized identification code, the first communications unit being assigned with a first identification code, said control method comprising the steps of:
a) through the first communications unit, receiving a communications signal transmitted from a second communications unit that has a second identification code and that transmits the communications signal upon dialing of the first identification code, and obtaining the second identification code of the second communications unit from the communications signal; and
b) through the processor, comparing the second identification code obtained in step a) with the at least one authorized identification code stored in the storage space, and controlling the automated door to permit access therethrough when a match is found.

2. The control method as claimed in claim 1, further comprising the step of:
c) through the processor, recording the second identification code obtained in step a) in an entry/exit log when a match is found in step b).

3. A control system for controlling access through an automated door, comprising:
a first communications unit assigned with a first identification code, and operable to receive a communications signal transmitted from a second communications unit that has a second identification code and that transmits the communications signal upon dialing of the first identification code, and to obtain the second identification code of the second communications unit from the communications signal;
a memory unit for storing at least one authorized identification code; and
a processor coupled to said first communications unit and said memory unit, and operable to compare the second identification code obtained by said first communications unit with the at least one authorized identification code stored in said memory unit, and to control the automated door to permit access therethrough when a match is found.

4. The control system as claimed in claim 3, wherein said processor records the second identification code obtained by said first communications unit in an entry/exit log stored in said memory unit when a match is found thereby.

5. The control system as claimed in claim 3, further comprising a transmission interface operably associated with said memory unit to permit uploading of data to and downloading of data from an external device.

6. The control system as claimed in claim 4, further comprising a transmission interface operably associated with said memory unit to permit uploading of data to and downloading of data from an external device.
